(19) United States
(12) Patent Application Publication
(10) Pub. No.: US 2007/0203876 A1
(43) Pub. Date: Aug. 30, 2007

(54) Method of evaluating and tracking records

(76) Inventors: John M. Hoopes, Washington, IL (US); Pauline C. Agbodjan-Prince, Peoria, IL (US); Douglas C. Meyer, Morton, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/362,832

(22) Filed: Feb. 28, 2006

(51) Int. Cl. G06F 17/30

(52) U.S. Cl. 707/1

(57) ABSTRACT

A method of evaluating records. The method includes compiling a first database with at least one record. The at least one record is indicative of a predetermined document having at least one data field that does not substantially match a respective data field of at least one other document. The method also includes accessing a second database and populating the at least one record with first data indicative of second data located within the at least one data field of the predetermined document. The method also includes identifying at least one entity, automatically notifying the at least one entity of the at least one record, and populating the at least one record with third data. The third data is different than the first and second data. The method further includes functionally comparing the at least one record with the at least one other document to determine if the first and third data of the predetermined document substantially matches the respective data field of the at least one other document.

### TECHNICAL FIELD

The present disclosure relates to a system for evaluating records and, more particularly, to a method and apparatus for evaluating and tracking documents.

### BACKGROUND

Systems for procuring products, such as, for example, goods or services, often include many documents that are transferred between entities, e.g., purchasers, suppliers, and/or schedulers, as the goods are manufactured, shipped, received, used, billed, and purchased. Typical documents include, for example, purchase orders, invoices, schedules, shipping notices, packing lists, bills of lading, and/or warehouse receipts, and are usually hardcopy paper documents. Additionally, such documents usually include a plurality of data such as, for example, product numbers, supplier names or numbers, product descriptions, quantities, delivery dates, and/or other data known in the art. Often, one or more documents associated with a single system for procuring products contain data which do not match respective data of at least one other document associated with the same system for procuring products. For example, an invoice indicating a certain quantity of products may not be matched with a warehouse receipt because no purchase order exists for the same quantity. Such unmatched documents are typically required to be matched, e.g., an invoice matched to a warehouse receipt, before an accounts payable department provides payment to a supplier. Often the unmatched documents are evaluated and resolved manually which delays payment to the supplier, requires resources to resolve, and/or strains business relationships between suppliers and purchasers.

U.S. Patent Application Publication No. 2002/0107794 (“the '794 application”) filed by Furphy et al. discloses a method and system for processing transactions. The system of the '794 application includes a central platform common to a plurality of buyers and a plurality of sellers to coordinate the processing of purchase orders and invoices therebetween. The central platform compares data associated with a purchase order with respective data associated with an invoice to find a corresponding match. If a match is not found, the method of the '794 application includes performing a workflow resolution to resolve discrepancies. The workflow resolution includes notifying a client, e.g., a buyer or seller, to review and revise data stored within the central platform, e.g., data associated with a purchase order originated by a buyer. Once the discrepancies have been resolved, the method of the '794 applications forwards a matched purchase order and invoice to accounts payable for further processing.

Although the system of the '794 application may discover and resolve unmatched purchase orders and invoices, a client may require specialized knowledge to make any revisions to data stored within the central platform. Additionally, a client of the '794 application may manually conduct investigations regarding any discrepancies which may be time consuming, require duplicating data provided by other personnel for revision of data within the central platform, and/or may incur procedures which are prone to error and/or resource intensive.

The present disclosure is directed to overcoming one or more of the shortcomings set forth above.

### SUMMARY OF THE INVENTION

In one aspect, the present disclosure is directed to a method for evaluating records. The method includes compiling a first database with at least one record. The at least one record is indicative of a predetermined document having at least one data field that does not substantially match a respective data field of at least one other document. The method also includes accessing a second database and populating the at least one record with first data indicative of second data located within the at least one data field of the predetermined document. The method also includes identifying at least one entity, automatically notifying the at least one entity of the at least one record, and populating the at least one record with third data. The third data is different than the first and second data. The method further includes functionally comparing the at least one record with the at least one other document to determine if the first and third data of the predetermined document substantially matches the respective data field of the at least one other document.

In another aspect, the present disclosure is directed to work environment for tracking records associated with a single entity procuring at least one product. The work environment includes at least one computer, a first database including at least one record populated therein, and a program. The program is configured to receive at least one first input from a first user and access the first database and automatically determine whether or not the at least one record is matched as a function of the at least one first input. The program is also configured to deliver at least one output to the first user indicative of whether or not the at least one record is matched and receive at least one second input from the first user. The program is also configured to automatically communicate with a second user as a function of the received at least one second input. The program is further configured to receive at least one third input from the second user as a function of the automatic communication.

In yet another aspect, the present disclosure is directed to a method for tracking records. The method includes populating a first database with first data indicative of at least one first document and populating the first database with second data indicative of information contained within the at least one first document. The method also includes comparing the second data with third data indicative of information contained within at least one second document and determining if the second data substantially matches the third data. The method also includes identifying an entity to populate the first database with fourth data if the second data does not substantially match the third data and automatically communicating with the identified entity to inform the identified entity to populate the first database. The method further includes automatically communicating with a user when the identified entity signals that the first database is populated with fourth data indicative of information regarding the at least one first document and being different than the second data.

### BRIEF DESCRIPTION OF THE DRAWINGS

FIG. 1 is a flow chart of an exemplary method for evaluating and tracking records in accordance with the present disclosure; and

FIG. 2 is a schematic illustration of an exemplary work environment for performing the method of FIG. 1.

### DETAILED DESCRIPTION

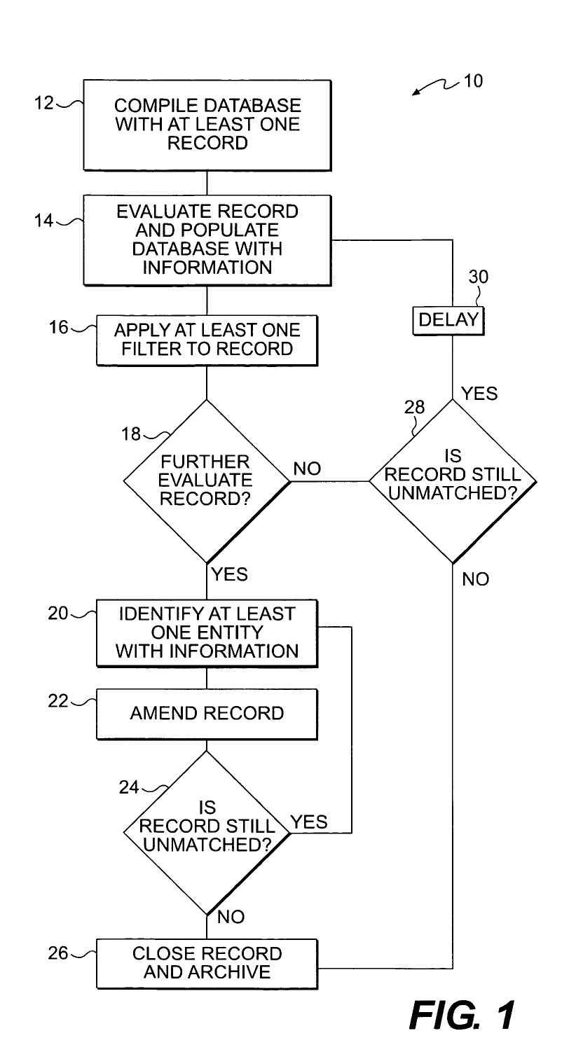

FIG. 1 illustrates an exemplary method 10 for evaluating documents. Method 10 may include compiling a database with at least one record, step 12. Method 10 may also include evaluating the record and populating the database with information, step 14. Method 10 may also include applying at least one filter to the record, step 16, and determining if the record should be further evaluated, step 18. If the record should be further evaluated, method 10 may identify at least one entity with information, step 20 and method 10 may include amending the record, step 22. Method 10 may also include determining if the record is still unmatched, step 24, and if not, method 10 may include closing and archiving the record, step 26. If the record is still unmatched, method 10 may return to and repeat steps 20 and 22. If, as determined in step 18, the record should not be further evaluated method 10 may include determining if the record is still unmatched, step 28. If the record is unmatched, method 10 may return to and repeat steps 14 and 16 after a delay 30. If the record is not unmatched, method 10 may progress to and perform step 26. It is contemplated that the steps associated with method 10 may be performed in any order and are described herein in a particular sequence for exemplary purposes only. It is also contemplated that method 10 may be performed continuously, periodically, singularly, as a batch method, and/or may be repeated as desired.

Step 12 may include compiling a database with at least one record. Specifically, step 12 may include populating a database with data indicative of at least one unmatched document associated with a system for procuring products. For example, step 12 may include inputting data into a database indicative of an invoice that does not substantially match, e.g., correspond to, a warehouse receipt, a shipping notice that does not substantially match a purchase order, and/or a bill of lading that does not substantially match a shipping notice. Step 12 may also include inputting data into the database indicative of, for example, a document number, e.g., an invoice number, a document identifier, e.g., a serial number for unmatched documents, and/or any other suitable identification. It is contemplated that a document may include one or more data fields therein, which may contain data, e.g., a product number, quantity, delivery date, purchase order number, and/or description. It is also contemplated that an unmatched document may include a document that has one or more data fields which do not substantially match a respective data field of at least one other document, e.g., a quantity of products associated with an invoice does not substantially match a quantity of products associated with any warehouse receipt. It is also contemplated that an unmatched document may include any type of document, e.g., a purchase order, a shipping notice, a bill of lading, a packing list, or a warehouse receipt, that does not substantially match a correspondingly desired document. It is further contemplated that products may include any type or quantity of goods, e.g., parts or components, services, e.g., manipulations or specific performances, and/or any other object that may be desired to be procured.

Step 14 may include evaluating the record and populating the database with information. Specifically, step 14 may include a user identifying data indicative of the unmatched document and determining that the record can be evaluated. Step 14 may include identifying one or more unmatched data fields associated with the unmatched document. Step 14 may also include the user populating the database with data indicative of the identified information. For example, a user may identify a record indicative of an invoice including a quantity of products that does not substantially match a quantity of products on a warehouse receipt. The user may determine that the respective quantities do not substantially match and may populate the database with data indicative of the data contained within the one or more data fields e.g., the product quantity, product number, delivery date, purchase order number, a price or currency, and/or description, of the invoice. It is contemplated that a user may access any suitable compilation of data, e.g., an invoice database, to find and/or copy data indicative of the information of the at least one unmatched document into the database populated with the at least one record.

Step 16 may include applying at least one filter to the record. Specifically, step 16 may include evaluating the record with respect to one or more tests and/or comparisons. Step 16 may include comparing the data populated into the database during step 14 with base data. The record may be tagged to include a particular identification, e.g., data indicative of a flag or other identification, if the compiled data and the base data satisfy a filter, e.g., substantially match or substantially do not match. For example, the populated data may be compared with one or more tables of data indicative of suppliers grouped according to product delivery lead times and the record may be appropriately tagged if at least a portion of the populated data, e.g., data indicative of a supplier, substantially matches base data indicative of an identified long lead time supplier. It is contemplated that the record may be tagged by inputting data into a data location, e.g., a comment field, appropriately associated with the record. It is also contemplated that the at least one filter may include any number or type of filter suitable for comparing data. It is further contemplated that step 16 may include a filter configured to determine if the record substantially matches another document.

Step 18 may include determining whether or not to further evaluate the record. Specifically, step 28 may include determining whether one or more of the filters applied in step 16 indicate that the record should not be presently evaluated. For example, a record may be determined to not be presently evaluated because one of the applied filters identifies the record as an invoice associated with products having a long delivery lead time, e.g., an invoice may be received before the products have been delivered. If the record is determined to be presently evaluated, method 10 may progress to step 20. If the record is not determined to be presently evaluated, method 10 may progress to step 28. Step 18 may also determine if the record has been tagged via appropriate filters within step 16. Specifically, step 18 may determine method 10 should progress to step 20, e.g., the record was filtered and identified as a record to be presently further evaluated or may determine method 10 should progress to step 28, e.g., the record was filtered and identified as a record to be evaluated for a potential match.

Step 20 may include identifying at least one entity having information regarding the record. Specifically, the user, e.g., an operator, may identify an entity, e.g., another user, that may have knowledge, experience, and/or additional information other than the data populated into the database during step 14. For example, the user may identify an entity associated with purchasing products, e.g., a receiving department, if a quantity of products of an invoice is determined to not match a quantity of products of a warehouse receipt. It is contemplated that an entity may be any group of personnel predetermined to have a common trait associated with the system for procuring products, e.g., a warehouse department, a scheduling department, a purchasing department, and/or any other suitable group known in the art. It is also contemplated that an entity may include any quantity of personnel, e.g., a single individual or a plurality of individuals and that the user and identified entity may be affiliated with a common business entity, e.g., a common buyer. It is further contemplated that a user may identify another entity that has knowledge, experience, and/or additional information as a function of the one or more unmatched data fields, a predetermined order of entities for obtaining information, and/or via any suitable method known in the art.

Step 20 may also include identifying at least one personnel associated with the identified entity and automatically notifying the entity and, in particular, the identified personnel, to request additional information regarding the record. Specifically, step 20 may include automatically sending an electronic mail to an identified entity and/or user associated with the identified entity, as a function of an input from the user, such as, for example, an electronic input from the user to identify the entity within a computer environment, e.g., a virtual object button executed by a keystroke of a computer input device or any other suitable identification. It is contemplated that the entity may be identified via an interactive drop down menu, as a single predetermined entity, and/or via any suitable method.

Step 22 may include amending the record. Specifically, step 22 may include an identified entity evaluating the data populated into the database during step 14 and adding additional data and/or confirming at least a portion of the existing data as being accurate. For example, the identified entity may evaluate the existing data and identify that the data indicative of a quantity associated with an invoice does not substantially match the data indicative of a quantity associated with a warehouse receipt. The identified entity may also determine that the warehouse quantity is correct and may, based upon knowledge, experience, authority, and/or any other suitable criteria, associated additional data with the record to correlate the data indicative of the warehouse receipt quantity to substantially match the data indicative of the invoice quantity. That is, the identified entity may selectively desire to authorize a credit or debit, e.g., accept the warehouse receipt quantity instead of requesting or returning products, for the invoice quantity of products and may amend data within the database accordingly. It is contemplated that the identified entity may amend the data in any suitable manner, such as, for example, by accessing the same database populated with data during step 14 and adding data therein. It is also contemplated that the identified entity may amend the data even if the identified entity confirms the data as being accurate. As such, the identified entity may input data indicating such a confirmation, e.g., by inputting data into the database within a comment location associated with the record. It is further contemplated that step 22 may include populating the database with data indicative of the amendments made by the identified entity, so as to, for example, track what data has been amended, why the data has been amended, and who amended the data.

Step 22 may also include automatically notifying the user that an identified entity has evaluated the record and amended the data accordingly. Specifically, step 22 may include automatically sending an electronic mail to the user as a function of an input from the identified entity, such as, for example, an electronic input from the entity, such as, for example, a virtual object button executed by a keystroke of a computer input device and/or any other suitable execution.

Step 24 may include determining whether the record is still unmatched. Specifically, step 24 may include comparing the data indicative of the record as amended within step 22 with data indicative of one or more other documents associated with the system for procuring products. Step 24 may include comparing data associated with one or more data fields of the unmatched document with data associated with respective data fields of the one or more other documents and determining if the data of the unmatched document substantially matches respective data of another document. For example, step 24 may include comparing data indicative of a quantity of products for an invoice with data indicative of a quantity of products for a warehouse receipt as amended, e.g., a received quantity and a credit or debit quantity, and determining that the respective data substantially match. If the document is still unmatched, e.g., each of the one or more data fields of the document do not substantially match a respective data field of another document, method 10 may return to step 20 to repeat steps 20 and 22. If the document is matched, e.g., each of the one or more data fields of the document substantially matches a respective data field of single other document, method 10 may progress to step 26. It is contemplated that if method 10 returns to and repeat steps 20 and 22, method 10 may or may not include identifying a new entity, different from the entity identified during the first sequence. It is also contemplated that step 24 may be automatically performed as a function of the input from the identified entity which may automatically notify to the user.

Step 26 may include closing and archiving the record. Specifically, step 26 may include the user amending the data indicative of the record to identify the record as being matched. For example, a user may add and/or remove data from the database to characterize the record as no longer requiring evaluating, e.g., by removing a tag supplied during step 12. Step 26 may also include storing a closed record within a database for a predetermined period of time, e.g., a particular quantity of days or months. It is contemplated that after the predetermined period of time has elapsed, the closed record may be removed from the database, e.g., deleted, permanently destroyed, moved to another database, erased, and/or be subjected to any other suitable method of removal. It is also contemplated that the closed record may be stored within the database populated with data during step 14. It is further contemplated that step 26 may include communicating the closed record with another entity, e.g., an accounts payable personnel, for further processing, e.g., payment, of the closed record. As such, the accounts payable personnel may issue payment as a function of the amended data, e.g., may issue payment for a quantity of goods different than that of the invoice as a function of a credit or debit identified within step 22.

Step 28 may include determining whether the record is still unmatched and may be substantially similar to step 24. Accordingly a detailed description of step 28 is omitted for clarification purposes. If the record is still unmatched, e.g., not matched, method 10 may progress to delay 30. If the record is matched, method 10 may progress to step 26. As such, method 10 may bypass steps 20, 22, and 24 when a record is originally identified as unmatched because insufficient data has been compiled into the database but subsequently becomes completed without identifying an entity having information, step 20, and amending the record, step 22.

Delay 30 may include any amount of time and may or may not be predetermined. Specifically, delay 30 may include an amount of time after which method 10 may return to step 14 to repeat step 14, e.g., evaluate the record and populate the database with information. It is contemplated that delay 30 may include any duration such as, for example, hours, days, months, and/or years. It is also contemplated that delay 30 may or may not be a function of one or more of the filters applied within step 16. For example, applying one or more filters within step 16 may identify the record as including products having a long delivery lead time wherein an invoice may be received before the products have been delivered. As such, delay 30 may be predetermined to be an estimated lead time for such products and step 14 may be repeated after expiration of delay 30.

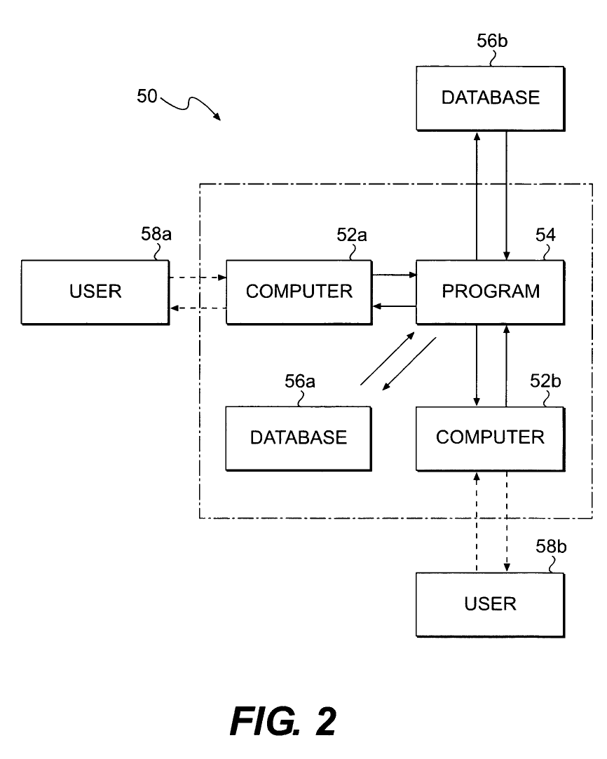

FIG. 2 illustrates an exemplary work environment 50 for performing method 10. Work environment 50 may include first and second computers 52a, 52b, a program 54, and first and second databases 56a, 56b. Work environment 50 may be configured to accept inputs from one or more users 58a, 58b via first and second computers 52a-b to track and evaluate one or more records. Work environment 50 may be further configured to communicate and/or display data or graphics to users 58a-b via first and second computers 52a-b. It is contemplated that work environment 50 may include additional components such as, for example, a communications interface (not shown), a memory (not shown), and/or other components known in the art.

First and second computers 52a-b may each include a general purpose computer configured to operate executable computer code. First and second computers 52a-b may include one or more input devices, e.g., a keyboard (not shown) or a mouse (not shown), to introduce inputs from users 58a-b into work environment 50 and may include one or more output devices, e.g., a monitor, to deliver outputs from work environment 50 to users 58a-b. Specifically, users 58a-b may input one or more inputs, e.g., data, into work environment 50 via first and second computers 52a-b to supply data to and/or execute program 54. First and second computers 52a-b may also include one or more data manipulation devices, e.g., data storage or software programs (not shown), to transfer and/or alter user inputs. First and second computers 52a-b may also include one or more communication devices, e.g., a modem (not shown) or a network link (not shown), to communicate inputs and/or outputs with program 54. It is contemplated that first and second computers 52a-b may further include additional and/or different components, such as, for example, a memory (not shown), a communications hub (not shown), a data storage (not shown), a printer (not shown), an audio-video device (not shown), removable data storage devices (not shown), and/or other components known in the art. It is also contemplated that first and second computers 52a-b may communicate with program 54 via, for example, a local area network (“LAN”), a hardwired connection, and/or the Internet. It is further contemplated that work environment 50 may include any number of computers, e.g., one computer or more than two computers, and that each computer associated with work environment 50 may be accessible by any number of users for inputting data into work environment 50, communicating data with program 54, and/or receiving outputs from work environment 50.

Program 54 may include a computer executable code routine configured to perform one or more sub-routines and/or algorithms to evaluate and track records within work environment 50. Specifically, program 54 may be configured to perform one or more steps of method 10. Program 54 may receive inputs, e.g., data, from either or both of first and second computers 52a-b, and perform one or more algorithms to manipulate the received data. Program 54 may also deliver one or more outputs, e.g., algorithmic results, and/or communicate, e.g., send electronic mail, to users 58a-b via first and second computers 52a-b. Program 54 may also access first and second databases 56a-b to locate and manipulate data stored therein to arrange and/or display stored data to one or more of users 58a-b via first and second computers 52a-b, e.g., via an interactive object oriented computer screen display. It is contemplated that program 54 may be stored within the memory (not shown) of first and/or second computers 52a-b and/or stored on a remote server (not shown) accessible by first and second computers 52a-b. It is also contemplated that program 54 may include additional sub-routines and/or algorithms to perform various other operations with respect to mathematically representing data, generating or importing additional data into program 54, and/or performing other computer executable operations. It is further contemplated that program 54 may include any type of computer executable code, e.g., C++, and/or may be configured to operate on any type of computer software, e.g., IBM's Lotus® software.

First and second databases 56a-b may be configured to store and arrange data and to interact with program 54. Specifically, first database 56a may be configured to store and arrange data indicative of the at least one record compiled during step 12 (referring to FIG. 1) and second database 56b may be configured to store and arrange data indicative of one or more documents associated with a system for procuring products for populating first database 56a with information during step 14 (referring to FIG. 1). First and second databases 56a-b may store and arrange any quantity of data arranged in any suitable or desired format. Program 54 may be configured to access first and second databases 56a-b to identify particular data therein and display such data to one or more of users 58a-b. For example, user 58a may access second database 56b, via program 54, to identify data stored therein indicative of information desired to be compiled within first database 56a. It is contemplated that first and second databases 56a-b may include any suitable type of database such as, for example, a spreadsheet, a two dimensional table, or a three dimensional table, and may arrange and/or store data in any manner known in the art, such as, for example, within a hierarchy, in groupings according to associated documents, and/or searchable according to associated identity tags.

Users 58a-b may include any entity configured to input data into work environment 50. For example, users 58a-b may include a system manager configured to evaluate one or more records stored within first database 56a, personnel associated with a system for procuring products, e.g., purchasers, schedulers, warehousemen, shippers, packers, accounts payable personnel, and/or any other entity associated with the procurement of products. For example, user 58a may populate first database 56a with data indicative of data stored within second database 56b and may perform steps 12,14, 20, and 26 and user 58b may amend data within first database 56a and may perform step 22.

### INDUSTRIAL APPLICABILITY

The disclosed system may be applicable for evaluating or tracking any type of records or documents. The disclosed system may also be applicable to evaluate and resolve unmatched documents within any system. The description above and explanation below of method 10 is made with reference to a system for procuring products, and in particular, with reference to evaluating an unmatched invoice with a warehouse receipt, for exemplary purposes only. It is noted that method 10 may be applicable to any type of system that includes evaluating and tracking records.

A purchaser may desire to procure a quantity of products from a supplier. Accordingly, the purchaser may complete a purchase order, e.g., may complete one or more electronic forms and/or object oriented computer screens. For example, the purchaser may identify a particular supplier, product type, quantity, deliver date, expected price, and/or any other type of information regarding the desired procurement. Each type of information may be represented or indicated as data assigned to a particular data field, e.g., a particular quantity may be assigned to a quantity data field. The data indicative of the information may be populated and stored within one or more databases and linked to and/or compiled within second database 56b.

The particular supplier may send a shipping notice, a bill of lading, the products, and an invoice, as a function of the received purchase order, to the purchaser for payment. The shipping notice, bill of lading, and the purchase order may be compared with one or more other documents to determine if a respective document substantially matches another. Specifically, the invoice may be received by an accounts payable department for handling and payment thereof. If the received invoice substantially matches a warehouse receipt, e.g., the respective quantities, product descriptions, and/or other respective information match, the accounts payable department may authorize payment to the supplier for the invoice. If the received invoice does not substantially match the warehouse receipt, the invoice may be identified as an unmatched document and may be identified as a record and compiled into a database, e.g., first database 56a, for further evaluation. It is contemplated that the invoice may be identified as an unmatched document because it does not substantially match a first document, e.g., a warehouse receipt, but does substantially match one or more other documents, e.g., a shipping notice or a purchase order. It is also contemplated that a document may be considered an unmatched document as a function of any number of the data fields not substantially matching a respective data field of at least one other document. It is further contemplated that a system for procuring products may include any quantity of documents associated therewith and a document may be identified as a record and compiled into a database because the document may not substantially match any particular or desired number or type of other documents.

With reference to FIG. 1 first database 56a may be compiled with a record of the unmatched invoice (step 12). For example, first database 56a may include a data location which stores data indicative of the record, e.g., a comment location that stores a description of the invoice and/or identifies the unmatched information. A user, e.g., user 58a, may evaluate the compiled record and populate first database 56a with data indicative of additional information regarding the unmatched invoice (step 14). For example, use 58a may access another database, e.g., second database 58b, and identify data therein pertaining to the unmatched invoice, e.g., supplier, part number, or quantity, and populate first database 56a with data indicative of the identified data. It is contemplated that the record may be compiled into first database 56a and user 58a may access second database 56b and populate first database 56a by performing one or more computer executable codes, e.g., program 54.

At least one filter may be applied to the record by, e.g., program 54, (step 16). For example, program 54 may be configured to perform one or more algorithms to compare data indicative of the supplier associated with the invoice and base data indicative of a list of suppliers providing products having a long delivery lead times. Program 54 may identify and/or tag the record as a function of the comparison of data. For example, program 54 may tag the record as being associated with a long lead time supplier by populating data with a identification location or via any other suitable data tagging method known in the art. It is contemplated that program 54 may automatically apply one or more filters to the record as a function of an input from user 58a indicating that step 14 has been completed.

Program 54 may determine whether or not the record should be presently further evaluated (step 18). For example, if program 54 tagged the record as being associated with a long delivery lead time supplier, program 54 may determine that the record should not be presently further evaluated because the quantity of products desired to be procured by the purchaser may not have been delivered and additionally information, e.g., the quantity received, may not yet be accessible within second database 56b. As such, program 54 may determine if the record is still unmatched (step 28) and, if not, user 58a may evaluate the record and populate first database 56a with additional information, e.g., the quantity of products received, after an elapsed period of time (delay 30). It is contemplated that program 54 may automatically determine if the record should be presently evaluated as a function of applying the one or more filters.

User 58a may identify at least one entity with information (step 20) if program 54 determines that the record should be presently further evaluated. For example, program 54 may not tag the record as being associated with a long delivery lead time supplier during step 16 and thus additional information may be required to resolve the unmatched invoice. As such, user 58a may, for example, identify the at least one entity as the purchaser that desired to procure the products. It is contemplated that user 58a may identify the purchaser by, for example, accessing a list of entities, e.g., a list identifying a purchasing department, a warehouse department, and/or a scheduling department, and selecting the purchasing department and/or executing an object oriented computer interface. Program 54 may, as a result of the selection by user 58a, communicate, e.g., automatically send an electronic mail, with the purchasing department and/or a specified personnel, e.g., the particular purchaser, associated with the purchasing department. It is also contemplated that the purchaser may be identified in any suitable manner such as, for example, by accessing a data field associated with the record indicating the particular purchaser, communicating with a representative contact personnel for the purchasing department to further communicate with the particular purchaser, and/or in any suitable manner. It is contemplated that program 54 may automatically communicate with the identified entity as a function of an input from user 58a, e.g., as a function of an entity selected from an interactive drop down list.

The purchaser, e.g., user 58b, may amend the record (step 22) and, specifically, may add data into first database 56a. For example, the user 58b may access first database 56a and evaluate the data indicative of the quantity of the invoice and may as a function of knowledge, experience, authority, and/or any other criteria, add data indicative of the warehouse receipt quantity to substantially match the data indicative of the invoice quantity. It is contemplated that user 58b may add any data, for example, user 58b may add data indicative of a reason for amending the warehouse receipt quantity within a comment data location. User 58b may also indicate that the record has been amended by, e.g., executing an object oriented computer interface. Program 54 may, as a result of the amendment by user 58b, and/or the executed object orientated computer interface, communicate, e.g., automatically send an electronic mail, with user 58a to indicate that user 58b has completed amending the record. It is also contemplated that user 58b may be amend the record by adding data indicative of a comment that a portion or all of the data associated with the invoice may be accurate and that user 58b may not have knowledge, experience, authority, and/or desire to change the data. It is further contemplated that user 58b may, alternatively, change data associated with the record and add data indicative of a reason for changing the warehouse receipt quantity within a comment data location.

Program 54 may determine if the record is still unmatched (step 24). For example, program 54 may functionally compare the data indicative of the invoice as amended by user 58b, e.g., data indicative of one or more data fields, with respective data indicative of one or more warehouse receipts. Program 54 may determine the invoice substantially matches a warehouse receipt and/or any other desired document, e.g., a shipping notice or a purchase order. If, for example, the invoice substantially matches a warehouse receipt, user 58a may close and archive the record (step 26). If the invoice does not substantially match a warehouse receipt, or other desired document, user 58a may identify at least one entity with information (step 20). For example, the invoice may either substantially match or not substantially match the warehouse receipt after the purchaser amends the quantity of the warehouse receipt. If the invoice and warehouse receipt substantially match, user 58a may determine the invoice to be acceptable, e.g., appropriate to be paid. As such, the invoice may be forwarded to an accounts payable department for further processing, e.g., payment. If the invoice and warehouse receipt do not substantially match, user 58a may determine the invoice to require further information from at least one entity. It is contemplated that user 58a may identify a new entity, e.g., personnel different than the purchaser, when step 20 is repeated or may identify the same entity, e.g., the purchaser, when step 20 is repeated if the purchaser has additional information or incorrectly and/or insufficiently amended the record during step 22. It is contemplated that program 54 may automatically determine if the record is still unmatched as a function of an input from user 58b, e.g., an input indicating to user 58a that the data has been reviewed and amended.

Because method 10 may include one or more users accessing a common database to resolve unmatched documents, the time and resources necessary for resolution of such unmatched documents may be reduced. Also, method 10 and work environment 50 may improve the business relationships between suppliers and purchasers. Additionally, because method 10 and work environment 50 may provide electronic data storage and electronic mail communication, the quantity, storage, e.g., maintaining paper files, and conventional communication, e.g., posting or facsimile, of hardcopy paper documents and paper communication may be reduced. Furthermore, method 10 may improve communication between entities affiliated with the same system for procuring products and/or the same business entity by reducing the number of paper documents, reducing duplication of data by allowing access to a common database, and/or by automatically performing one or more steps associated with resolving unmatched documents.

It will be apparent to those skilled in the art that various modifications and variations can be made to the disclosed system for evaluating and tracking records. Other embodiments will be apparent to those skilled in the art from consideration of the specification and practice of the disclosed method and apparatus. It is intended that the specification and examples be considered as exemplary only, with a true scope being indicated by the following claims and their equivalents

What is claimed is:

1. A method for evaluating records comprising:
compiling a first database with at least one record, the at least one record indicative of a predetermined document having at least one data field that does not substantially match a respective data field of at least one other document;
accessing a second database and populating the at least one record with first data indicative of second data located within the at least one data field of the predetermined document;
identifying at least one entity and automatically notifying the at least one entity of the at least one record;
populating the at least one record with third data, the third data being different than the first and second data; and
functionally comparing the at least one record with the at least one other document to determine if the first and third data of the predetermined document substantially matches a respective data field of the at least one other document.

2. The method of claim 1, wherein populating the at least one record with first and third data includes storing data associated with the at least one data field of the predetermined document within the first database.

3. The method of claim 1, wherein:
the predetermined document is one of an invoice, a purchase order, a shipping notice, a packing list, a warehouse receipt, or a bill of lading;
the predetermined document is associated with a first system for procuring products;
the at least one other document is one of an invoice, a purchase order, a shipping notice, a packing list, a warehouse receipt, or a bill of lading; and
the at least one other document is associated with the first system for procuring products.

4. The method of claim 1, wherein:
the at least one data field of the predetermined document includes a plurality of data fields;
the at least one other document includes a plurality of respective data fields;
the first and third data are each associated with one or more of the plurality of data fields; and
functionally comparing the at least one record with the at least one other document includes functionally relating each of the plurality of data fields of the at least one record with a respective data field of the at least one other document.

5. The method of claim 1, further including:
identifying the at least one record as complete if the first and third data of the at least one record substantially matches the respective data field of the at least one other document; and
populating the at least one record with fourth data, the fourth data being different than the first, second, and third data.

6. The method of claim 5, further including:
archiving the at least one record identified as complete; and
deleting the at least one record identified as complete from the first database after an elapsed predetermined period of time.

7. The method of claim 1, further including filtering the at least one record by comparing the first data with base data and identifying the at least one record with a data tag if the first data substantially matches the base data.

8. The method of claim 1, wherein:
the first and second databases are electronic databases and are configured to be accessible by a computer executable program; and
the first database is different than the second database.

9. A work environment for tracking records associated with a single entity procuring at least one product comprising:
at least one computer;
a first database including at least one record populated therein; and
a program configured to:
receive at least one first input from a first user and access the first database,
automatically determine whether or not the at least one record is matched as a function of the at least one first input,
deliver at least one output to the first user indicative of whether or not the at least one record is matched,
receive at least one second input from the first user,
automatically communicate with a second user as a function of the received at least one second input, and
receive at least one third input from the second user as a function of the automatic communication.

10. The system of claim 9, wherein the program is further configured to automatically communicate with the first user as a function of the received at least one third input.

11. The work environment of claim 9, wherein automatically communicating includes the program sending an electronic mail to the first user.

12. The work environment of claim 9, wherein the at least one computer is configured to communicate the at least one input from the first user to the program.

13. The work environment of claim 9, wherein applying the at least one filter to the record includes comparing the first data with base data and identifying the at least one record with a data tag if the first data substantially matches the base data.

14. The work environment of claim 13, wherein the program is further configured to apply at least one filter to the record, the at least one filter configured to compare the at least one record with at least one of a supplier listing or a product listing.

15. The work environment of claim 9, wherein the program is further configured to:
determine whether or not the at least one record is matched after receiving the at least one third input;
receive at least one fourth input from the first user if the program determines the at least one record is not matched; and
automatically communicate with a third user as a function of the received at least one third input.

16. The work environment of claim 9, wherein determining if the at least one record is matched includes:
functionally relating first data indicative of the at least one record with second data stored within one of the first database or a second database; and
functionally determining if the first data substantially matches the second data;
wherein the second data is indicative of at least one document and the at least one record and the at least one document are each one of an invoice, a purchase order, a shipping notice, a packing list, a warehouse receipt, or a bill of lading, each of which is established by the single entity.

17. A method of tracking records comprising:
populating a first database with first data indicative of at least one first document;
populating the first database with second data indicative of information contained within the at least one first document;
comparing the second data with third data indicative of information contained within at least one second document;
determining if the second data substantially matches the third data;
identifying an entity to populate the first database with fourth data if the second data does not substantially match the third data;
automatically communicating with the identified entity to inform the identified entity to populate the first database; and
automatically communicating with a user when the identified entity signals that the first database is populated with fourth data indicative of information regarding the at least one first document and being different than the second data.

18. The method of claim 17, further including:
comparing the third data with the second and fourth data; and
determining if the third data substantially matches the second and fourth data.

19. The method of claim 17, wherein populating the first database with second data includes accessing a second database containing fifth data indicative of the information contained within the at least one second document.

20. The method of claim 17, wherein each of the at least one first document and the at least one second document are:
one of an invoice, a purchase order, a shipping notice, a packing list, a warehouse receipt, or a bill of lading; and
associated with a single system for procuring products.

21. The method of claim 17, wherein:
populating the first database with first data includes populating the first database with first data indicative of a plurality of first documents;
populating the first database with second data includes populating the first database with second data indicative of information contained within at least one of the plurality of first documents;
the at least one second document is a plurality of second documents, each of the plurality of second documents including third data;
each of the plurality of first documents is indicative of a document predetermined to not substantially match at least one of the plurality of second documents; and
comparing the second data with third data includes comparing the second data associated with at least one of the plurality of first documents with at least a portion of the third data indicative of at least one of the plurality of second documents.

22. The method of claim 21, further including automatically determining if the second data associated with at least one of the plurality of first documents substantially matches third data associated with one of the plurality of second documents.
